(19) United States
(12) Patent Application Publication
(10) Pub. No.: US 2015/0012980 A1
(43) Pub. Date: Jan. 8, 2015

(54) Systems and methods for secure singular computing environment

(71) Applicant: Waldemar Mikolajczyk, Northborough, MA (US)

(72) Inventor: Waldemar Mikolajczyk, Northborough, MA (US)

(21) Appl. No.: 14/215,016

(22) Filed: Mar. 16, 2014

Related U.S. Application Data
(60) Provisional application No. 61/801,955, filed on Mar. 15, 2013.

(51) Int. Cl. H04L 29/06; G06F 21/60

(52) U.S. Cl. CPC H04L 63/08; G06F 21/60
USPC 726/5; 726/26

(57) ABSTRACT

A secure computing environment where malicious software cannot replicate cannot interact with legitimate applications running on the computer system. Each legitimate computer application obtains unique encrypted application programming interface. Application programming interface is unique on every system wherein computer application is executed. Structure of application programming interface can be dynamic. Structure can change with each application's invocation and can change over time. If a device driver is interoperating with computer application, it possess relevant unique encrypted application programming interface. Each legitimate application can interact only with authorized drivers. Secure computing domain is created where each individual system is unlike any other and each software component on a system is unlike the same or similar software component on another system.

### RELATED APPLICATION

This application claims priority from, and is continuation of U.S. Provisional Application Ser. No. 61/801,955, filed Mar. 15, 2013.

### BACKGROUND OF THE INVENTION

### Field of the Invention

This invention relates generally to the field of computer systems security, and more particularly to protection against malicious software attacks and protection against computer system infection. Moreover, it pertains specifically to computer security framework to create unique/singular computing environment per every computing system and per every software application executed in every computer system. Singularity based security blocks any unauthorized software actions like malicious software execution, malicious software self-replication/infection and unauthorized data consumption or alteration.

### SUMMARY OF THE INVENTION

In view of the limitations now present in the prior art, the present invention provides a new and useful “Systems and methods for secure singular computing environment” which has new functional capabilities, is universally usable, and is more versatile in operation than known methods to achieve security and protection against malicious software.

The purpose of the present invention is to provide a new useful “Systems and methods for secure singular computing environment” that has many novel features not offered by the prior art methods that result in a useful way to provide security within computer networks, security within computer system, computer applications security and security of application data within computer networks and systems which is not apparent, obvious, or suggested, either directly or indirectly by any of the prior art apparatus.

There are many known methods and inventions related to network security, computer system security, application security and security of application data. They are related to Anti-Virus protection, Anti-Rootkit protection, malware protection, Computer and Network Firewalls, DRM (Digital Rights Management), ERM (Enterprise Rights Management), IRM (Information Rights Management), or related technologies. They address many different aspects of security, access and consumption control. The unique characteristics of the current innovation allow for its application to the generic field of computer networks and systems and, in particular, Mobile Computing. Computer software/Computer applications created, distributed and deployed in accordance of principles of current innovation have a set of unique security characteristics very different from characteristics of currently known methods to create, distribute and deploy Corporate or personal software on existing networks and computer systems. Current process of creation, distribution and deployment of computer software has extremely distributed characteristics involving tens, hundreds or even thousands of active parties, parties that can be spread over multiple sites, often located on separate continents. In addition, computer applications can be dispersed into tens of thousands individual installations and at the same time are subject to extremely distributed attacks utilizing wide spectrum of known and unknown methods of attacks and exploitation. None of the previously known methods address issues specific to security protection scalability, dynamics of attacks and application data access granularity.

The invention addresses all issues specific to security of computer networks, computer systems, computer applications and application data security. The invention protects integrity of computer network, individual computer systems. The invention also protects integrity of deployed computer applications together with their application data and user data.

By computer system is understood any information processing device. Personal computers, computer system mobile device, computer controlled industrial controller are examples of computer systems. By computer network is understood conglomerate of computer systems interoperating and connected through computer network. Computer systems can run under control of well-known generic Operating System or specific/proprietary Operating System. Operating System is responsible for management of resources comprising computer system. In particular Operating System controls allow deployment of third party computer applications. Functional characteristics of computer applications are not known in advance. In particular, it is unknown application's structure, its engagement with other computer systems in the network, its usage of individual resources within computer system. Resources within computer system are understood as other installed applications and their data files.

Uncontrolled distribution of malicious software takes advantage of unpredictability of functional characteristics of new applications combined with currently existing uniformity of computer systems and computer networks.

The invention addresses problem of uncontrolled distribution of malicious software by creation of secure processing environment. Secure processing environment takes advantage of deployed singular processing characteristics per computer system and per application installed on computer system. Singular processing characteristics blocks completely uncontrolled software distribution and in particular blocks distribution of malicious software.

As a side effect of invented controlled software distribution—the invention addresses problems related to licensing of computer applications/computer software. Licensing is understood as compliance to authorized software deployment and usage terms. While invention principles focus primarily on protection against malicious software—its embedded principles of software authorization can be expanded to address requirements defined by licensors or software vendors.

It is important to remember that properties of license conditions can change over time, and they can depend on a particular user and his computer system or user attribute related to particular computer network.

The invention addresses problems related to protection of computer data files as well. Application data files or user data files are examples of computer data files. It is currently common practice that computer applications use/process multiple active computer data files. Every instance of data file may have its own set of policies for access, usage and consumption. Access control policies can be used to protect individual computer data files against uncontrolled and unauthorized consumption, alternation and internal and external copying. Access control policies go beyond controlling application files as a whole, they also include ability to control access to individual sub-records in protected records comprising computer data file.

Unique characteristic of computer applications and computer data files is the strong technical expertise of their creators and maintainers. In particular, an expertise that may include areas of document protection and encryption. This fact forces the invention method to be tamper-proof against malicious consumers and malicious computer applications.

Another unique characteristic of computer data files is the variety of applications used to create, maintain and use them. In addition, individual application may have multiple versions present in active usage. The invention also provides data computer files protection in such variable dynamic environment.

### PHYSICAL DESCRIPTION OF THE INVENTION

The present invention is comprised of multiple interoperating software modules executed on multiple logically or physically interconnected computer systems. There are two classes of interoperating computer systems:
1. servers running specialized computer software responsible for
   1.1. maintenance of protected computer data files
   1.2. maintenance of access and access control policies, defined by an appropriate administrative entity
   1.3. distribution of computer applications and related data files to end users/consumers
   1.4. protection, encryption or customization of computer applications and relevant computer data files before their distribution to the user/consumers
2. end users' computer systems/workstations/mobile devices running distributed software
   2.1. user computer systems are responsible for
      2.1.1. enforcement of licensing terms and access control policies for protected computer applications and computer data files
      2.1.2. enforcement of run-time policies to install and execute computer applications
      2.1.3. enforcement of access control policies to access or manipulate common computer data files or to access or manipulate individual records/sub-records within computer data files
      2.1.4. decryption of protected computer data files and their conversion into formats accepted by other processing software modules
      2.1.5. enforcement of access control policies to create computer data files

Any computer system belonging to any class of classes described above can perform all or any subset of the software modules listed above.

End user computer system executing the software modules may also run server software modules and end user computer system software modules on the same machine. Computer system working according to such a method comprise a server-less execution environment.

The foregoing has outlined the physical aspects of the invention and its ability to serve as an aid to a better understanding of the more complete, detailed description that follows. In reference to the above, it should be understood that the present invention is not limited to the method or detail of construction, fabrication, material, or application of use described and illustrated herein. Any other variation of fabrication, use, or application should be considered apparent as an alternative embodiment of the present invention.

### ABSTRACT OF THE DISCLOSURE

Multiple interoperating software modules will be running on the single or multiple logically or physically interconnected computer systems. Execution of these software modules will enforce allowed access and execution policies. Enforcement of relevant policies will maintain integrity of complete computing environment. By complete computing environment it is understood conglomerate of running Operating System together with installed applications and related computer data files. Integrity is maintained while computer data files or their part are/is created, transferred or processed within the computer environment.

Computer environment security is maintained by enforcements and usage of singular customized set of system calls. Individual instance of singular set of system calls is created per every individual computer system and per every installed software module on computer system. By installed software module ii is understood every installed application and every installed driver or every installed kernel expansion module.

Singular set of system calls is created during application or driver installation and it is valid for interactions only between operating system and relevant application or driver. Set of system calls can be valid only according to defined access policy, e.g. during predefined time period or predefined usage model. Access policy has an option to extend its validity.

Confidentiality of computer data files is maintained through data file encryption. Encryption keys are unique per computer data files. Encryption keys are maintained by operating system and prevent usage by unauthorized software modules.

Computer data files encryption is in effect while they are transferred between authorized secure computer systems, while they are stored at computer system local persistent memory or optionally when they are stored at computer local volatile memory. The invention can be used in any computer environment where computer system security together with confidentiality of data files is desired, expected or required. Execution of software modules comprising invention do not interfere with end user's work flow as well do not require any specific actions to be performed by user.

In addition, dedicated software modules provide tamper-proof protection against malicious users and any malicious software application attempting to by-pass access and execution policy. Protection is in effect also while computer data file is present in computer operational memory in decrypted, non-protected format (as required by processing application).

Dedicated software modules enforce and maintain execution, access and access control policy defined by the manufacturer of computer system or owner of the computer system. Security policy may also take into consideration licensing terms for installed applications with their related data files.

Method to enforce execution, access and control access policies is capable to scale up and to control any set of applications and their related data files. Protection can be achieved with a single or multiple defined number of policies.

### OBJECTS OF THE INVENTION

Accordingly several advantages and objects of the present invention are:

A principal object of the present invention is to provide a method for achieving computer infrastructure security together with running and installed applications and their data files that will overcome the deficiencies of the prior art solutions and prior art systems.

An object of the present invention is to provide a method that is transparent to any user's applications workflow executed on the end user computer system. Method doesn't impose any additional user operation during application invocation and execution. Method doesn't impose any additional user operation during creation and processing of relevant data files.

Another object of the present invention is to provide a method that is transparent to any applications ability to create or to manipulate relevant data files, located on the end user computer system. Method automatically enforces and maintains security and confidentiality of created, consumed or altered data files without any additional user intervention.

Another object of the present invention is to provide method that is capable to enforce and maintain confidentiality of data files while there are stored on computer's persistent or volatile memory.

Another object of the present invention is to provide method that is tamper-proof against malicious user and malicious applications attempting to access, consume or alter saved computer data files.

Another object of the present invention is to provide method that is tamper-proof against malicious users and malicious applications attempting to access, consume or alter computer data files while they are stored in computer volatile memory in a decrypted state and processed by authorized applications.

Another object of the present invention is to provide method that is tamper-proof against malicious users and malicious applications attempting to alter running or installed computer applications.

Another object of the present invention is to provide method capable to recognize non-authorized actions performed by malicious users or malicious applications while attempting to jeopardize computer infrastructure security or confidentiality of data files.

Another object of the present invention is to provide a method that is capable to detect malicious modifications to user's computer infrastructure jeopardizing system integrity and jeopardizing computer infrastructure security or confidentiality of data files.

Another object of the present invention is to provide method capable to block malicious applications or malicious users responsible for performed non-authorized actions or malicious modifications while attempting to jeopardize computer infrastructure security or confidentiality of data files.

Another object of the present invention is to provide a method that is universally functional and operates according to the same principles on individual computer system and as well on a group of distributed computer systems creating computer network.

Another object of the present invention is to provide a method that is more universally functional in today's market than the prior art methods or/and systems.

A further objective of the present innovation is to increase tamper-proof characteristic of the invented method against malicious users and their applications.

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1. is a diagram of “Generic computing infrastructure” according to present invention.

FIG. 2. is a diagram of a “Generic computer system hardware diagram with marked areas for security protection” according to the present invention.

FIG. 3. is a diagram of a “Generic computer system software diagram with security protection software modules” according to the present invention.

FIG. 4. is a diagram of a “Successful Application installation sequence” according to the present invention.

FIG. 5. is a diagram of a “Successful Application and Driver installation sequence” according to the present invention.

FIG. 6. is a diagram of a “Failed Application installation sequence” according to the present invention.

FIG. 7. is a diagram of a “Application invocation sequence”

FIG. 8. is a diagram of a “Driver invocation sequence”

### DETAILED DESCRIPTION OF THE INVENTION

The invention provides a computer system security and running application security by creation and enforcements of unique/singular Operating Systems characteristics. Created singular characteristics are related set of system calls per device, per installed application and per every installed device driver operating within protected computer system.

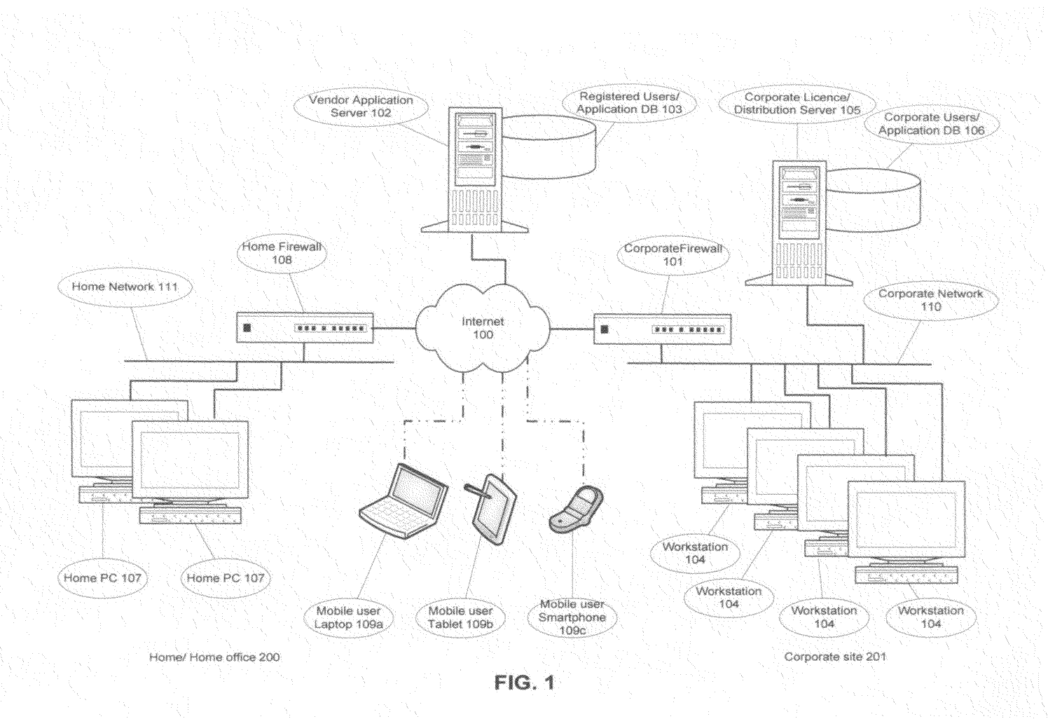

FIG. 1 illustrates a typical computer network environment where expansion user applications and device drivers are installed and used. In addition to end user computing devices, diagram indicated Application validation servers participating in creation and enforcement of security procedures according to embodiment of the invention. The network is comprised of one or more of the Corporate sites 201, one or more of the home/home office sites 200, multiple types of Mobile Users devices like smartphone 109, Tablets 110 or laptops 111. Corporate site 201 is connected to Internet 100 through Corporate Firewall 101, home office site 200 is connected to Internet 100 through Home Firewall device 108. Mobile users 109, 110, and 111 may be connected directly to Internet 100. Corporate site 201 is comprised of a set of Workstations 104 and one or more Corporate License/Distribution Servers 105. Servers 105 maintain Corporate Users/Applications DB 105. Corporate License/Distribution Server 105 allows corporation to enforce and control their own security procedures according to embodiment of the invention. Home/home office sites may use Vendor Application Server 102 to perform similar security procedures enforcement functions. There is also a possibility that Application Server may be embedded into individual Home PC 107, individual Workstation 104 or Individual Mobile device 109, 110, 111. In last case Application Server cannot provide complete validation of individual, new application against known security risk or usage compliance policies. It will however perform all required security procedures to protect computer system, rest of installed applications and stored data files against potentially malicious operations. Malicious operations in this case may be performed by new application. It is important to remember that, as illustrated on FIG. 1, the network has no strictly defined boundaries. The Corporate site 201 is under the control of the individual corporation and not under the control of the Application Vendor or equipment vendor. As a rule vendor provides its equipment and applications to be installed and used at multiple Corporate sites and multiple Home/Home office sites.

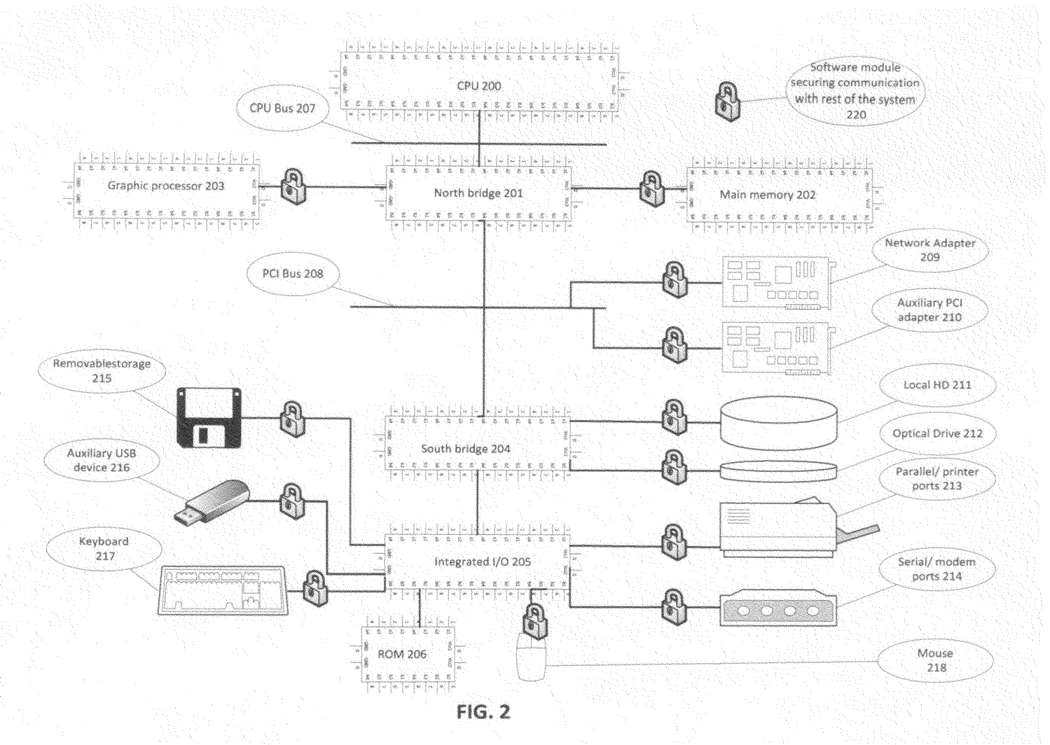

FIG. 2 illustrates the generic hardware architecture of the workstation. The generic architecture comprises of, but it is not limited to, a Central Processing Unit 200, North Bridge 201 chip, Main memory 202, Graphic Processor 203, South Bridge 204, Integrated I/O 205, ROM device 206, CPU Bus 207, PCI Bus 208 and multiple specialized peripheral devices. The diagram includes multiple lock signs to mark the areas where there is potential to malware software to perform unauthorized actions. Marked areas also indicate need for security software modules to provide required protection. In particular, additional protection, crypto-engine modules are present on the
1. channel communicating with Graphic Processor 203
2. channel communicating with Network Adapter 209
3. channel communication with Auxiliary PCI Adapter 210
4. channel communicating with Local Hard Drive 211
5. channel communicating with Optical Drive 212
6. channel communicating with Parallel Ports or Printer 213
7. channel communicating with Serial Ports or Modems 214
8. channel communicating with Removable Storage devices 215
9. channel communicating with Auxiliary USB devices 216

Every crypto-engine module provides unique secure communication channel with core of the system and prevents installed, not fully authorized application or device driver from performing unauthorized actions and expanding its malicious functionality to authorized applications/drivers and data files.

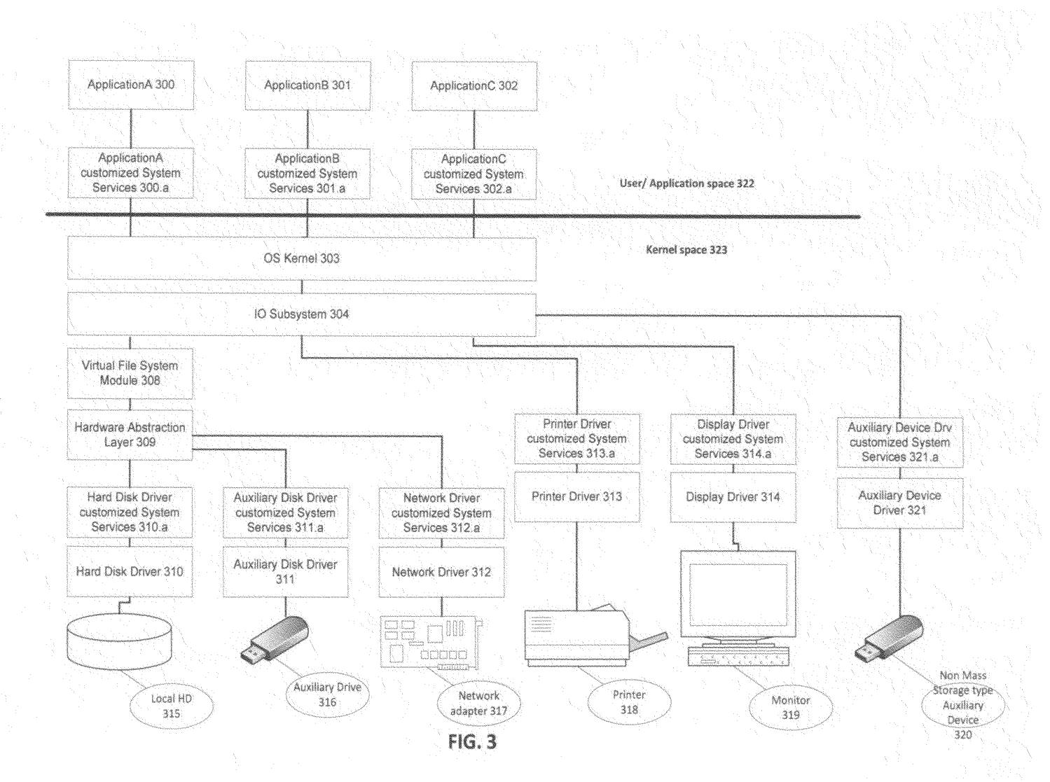

FIG. 3 illustrates the generic software architecture of the workstation. Architecture of Home/Home Office PC or Mobile Device may be subset of presented Workstation architecture. The generic software architecture is comprised of the software modules running either in User/Application space 322 or in Kernel space 323. The separation of the User and Kernel mode provides a higher resiliency to internal software failures and, in particular, to failures introduced by the user applications 300, 301, 302. Each user Application communicates with the external devices and common system services through the individual Application customized System Services module 300a, 301a, 302a executed in User Application space 322. Each Application customized System Services module is capable of communicating with the OS Kernel 303. Kernel space 323 includes multiple interoperating software modules. In particular it includes:
1. OS Kernel 303
2. IO Subsystem 304
3. Virtual File System Module 308
4. Hardware Abstraction Layer 309
5. Hard Disk Driver 310
6. Auxiliary Disk Driver 311
7. Network Driver 317
8. Printer Driver 313
9. Display Driver 314
10. Auxiliary Device Driver 321

FIG. 3 also shows some of Computer system hardware resources controlled by appropriate drivers like:
1. Local Hard Drive (HD) 315
2. Auxiliary Drive 316
3. Network adapter 317
4. Printer 318
5. Monitor 319
6. Non Mass Storage type Auxiliary Device 320

In addition to previously listed OS Kernel software modules, invention adds variety of matching crypto Application System Services API responsible for isolation of running Applications from each other. OS Kernel 303 communicates with IO Subsystem 304. The diagram includes the software modules responsible for maintaining required security and protection from every peripheral device. The listed protection software modules:
1. Hard Disk Driver customized System Services 310a
2. Auxiliary Disk Driver customized System Services 311a
3. Network Driver customized System Services 312a
4. Printer Driver customized System Services 313a
5. Display Driver customized System Services 314a
6. Auxiliary Device Driver customized System Services 321a

Each of Device Driver's customized crypto System Services Module interacts with I/O Subsystem 304. I/O Subsystem 304 includes variety of matching crypto Device Driver System Services API responsible for isolation of running Device Drivers from each other and protection of Driver's managed data resources from malicious access by other drivers.

Each of Device Driver customized System Services Modules interacts with appropriate Device Driver managing particular peripheral device.

By crypto module, crypto-engine module or crypto system service API it is understood any of the following or any combination of the software modules using
1. Public/private encryption
2. Symmetric encryption
3. Hashing operations

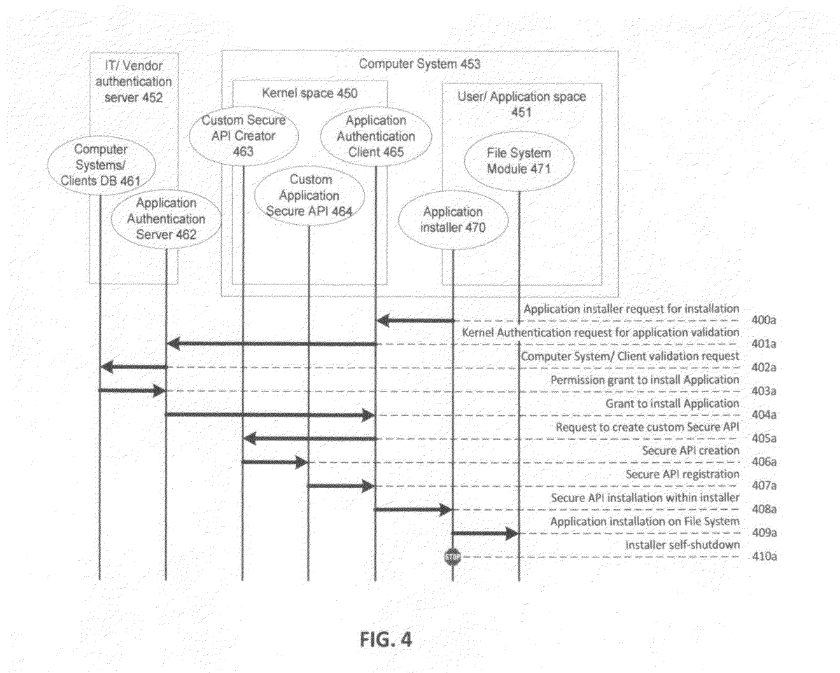

FIG. 4 illustrates the operations during “Successful Application installation sequence” according to present invention. Application is installed in Computer System 453 and after completion of the installation will be executed in User/Application space 451, shared with other installed applications. Installed Application doesn't include any new Drivers/Kernel space modules required for its execution. Installation begins from installation request 400a initiated by Application Installer 470. Request is passed through only open, well known interface/system call to Application Authentication Client 465. Application Authentication Client is running in Kernel Space 450. Application installation request contains all expected identification information about newly installed application. Application Authentication Client 465 combines application identification information with Computer System 453 identification information together with user identification information. Combined identification information is included into Kernel Authentication request for application validation 401a and it is passed to Application Authentication Server 462. Application Authentication Server 462 is running on IT/Vendor Authentication Server 452. IT/Vendor Authentication Server 452 functionality can be part of Corporate IT infrastructure or it can be dedicated Vendor (or Application Distributor) Server placed on the Internet or it can be placed directly on Computer System 453 itself.

Application Authentication Server 462 issues Computer System/Client request 402a to Computer Systems/Clients DB 461. After receiving Permission grant to install Application 403a it issues Grant to install Application 404a to Application Authentication Client 465. After receiving Grant to install Application 404a, Application Authentication Client 465 initiates Request to create custom Secure API 405a. Request to create customer Secure API 405a is sent to Custom Secure API creator 463. Application Secure API creation 406a step is performed and Custom Application Secure API 464 is installed in Kernel Space 450. Newly created Custom Application Secure API 464 performs Secure API registration 407a within Application Authentication Client 465. Credentials of secure API are passed to Application installer 470 and Secure API installation within installer 408a is performed. Installed Secure API is included within newly installed application during Application installation 409a on File System 471. After completion of Application installation 409a, Installer self-shutdown 410a is performed. Application installation is completed. In the future when newly installed Application will be invoked and executed, it will use its own Secure API to communicate with rest of Computer System 453.

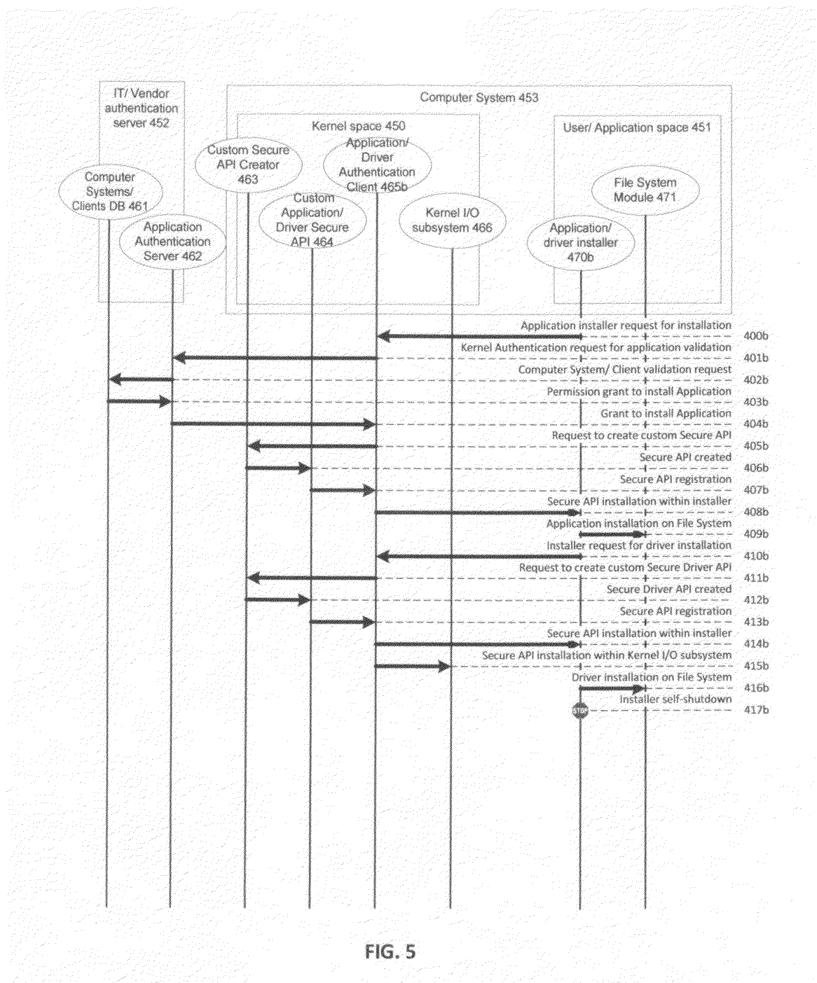

FIG. 5 illustrates the operations during “Successful Application and Driver installation sequence” according to present invention. Application is installed in Computer System 453 and after completion of the installation will be executed in User/Application space 451, shared with other installed applications. Installed Application includes new Drivers/Kernel space modules required for its execution. Installation begins from installation request 400b initiated by Application/Driver Installer 470b. Request is passed through only open, well known interface/system call to Application/Driver Authentication Client 465b. Application Authentication Client is running in Kernel Space 450. Application installation request contains all expected identification information about newly installed application. Application Authentication Client combines application identification installation with Computer System 453 identification information together with user identification information. Combined identification information is included into Kernel Authentication request for application validation 401b and it is passed to Application Authentication Server 462. Application Authentication Server 462 is running on IT/Vendor Authentication Server 452. IT/Vendor Authentication Server 452 functionality can be part of Corporate IT infrastructure or it can be dedicated Vendor (or Application Distributor) Server placed on the Internet or it be dedicated server functionality placed directly on Computer System 453 itself.

Application Authentication Server 462 issues Computer System/Client request 402b to Computer Systems/Clients DB 461. After receiving Permission grant to install Application 403b it issues Grant to install Application 404b to Application/Driver Authentication Client 465b. After receiving Grant to install Application 404b, Application/Driver Authentication Client 465b initiates Request to create custom Secure API 405b. Request to create customer Secure API 405b is sent to Custom Secure API creator 463. Application Secure API created 406b step is performed and Custom Application Secure API 464 is installed in Kernel Space 450. Newly created Custom Application Secure API 464 performs Secure API registration 407b within Application/Driver Authentication Client 465b. Credentials of secure API are passed to Application/Driver installer 470b and Secure API is installed within installer 408b. Installed Secure API is included within newly installed application during Application installation on File System 409b. After completion of Application installation, Installer sends Request for driver installation 410b to Application/Driver Authentication Client 465b. Application/Driver Authentication Client sends Request to create custom Secure Driver API 411b to Custom Secure API Creator 463. Custom Secure Driver API creation 412b step is performed and Custom Driver Secure API 464 is installed in Kernel Space 450. Newly created instance of Custom Driver Secure API 464 performs Secure API registration 413b within Application Authentication Client 465b and in the following performs registration 415b within Kernel I/O subsystem 466. Installed Secure API is included within newly installed driver during final Driver installation 416 on File System 471. Steps 410b through 416b are repeated for every new driver added to the system during Application/Driver installation.

After completion of Application and Drivers installation, Installer self-shutdown 417b is performed. Application and driver(s) installation is completed. In the future when Application will be invoked and executed, it will use its own Secure API to communicate with the rest of Computer System 453. Each installed Driver will also use its own Secure API to communicate with the rest of Computer System 453

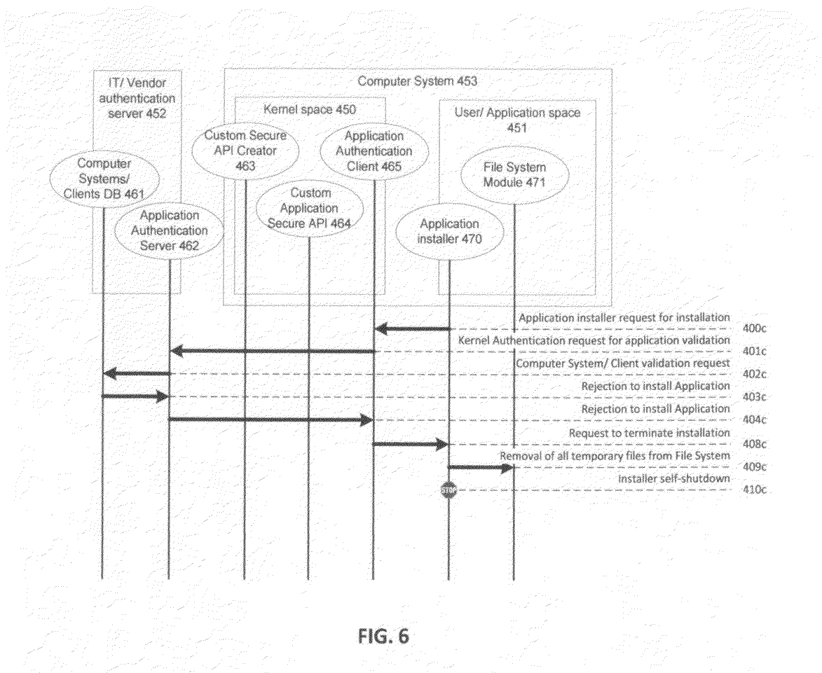

FIG. 6 illustrates the operations during “Failed Application installation sequence” according to present invention. Installation begins from installation request 400c initiated by Application Installer 470. Request is passed through the only open, well known interface/system call to Application Authentication Client 465. Application Authentication Client is running in Kernel Space 465. Application installation request contains all expected identification information about to be installed new application. Application Authentication Client combines application identification installation with Computer System 453 identification information together with user identification information. Combined identification information is included into Kernel Authentication request for application validation 401c and it is passed to Application Authentication Server 462. Application Authentication Server 462 is running on IT/Vendor Authentication Server 452. IT/Vendor Authentication Server 452 functionality can be part of Corporate IT infrastructure or it can be dedicated Vendor (or Application Distributor) Server placed on the Internet or it be dedicated server functionality placed directly on Computer System 453 itself.

Application Authentication Server 462 issues Computer System/Client request 402c to Computer Systems/Clients DB 461. After analyzing Computer Systems/Clients DB credentials and policies request to install Application—Rejection to install Application 403c is issued. Application Authentication server issues Rejection to install Application 404c to Application Authentication Client 465. After receiving Rejection to install Application 404c, Application Authentication Client 465 sends Request to terminate installation 408c to Application installer 470. Application installer removes all temporary files from the File System 409c and Installer self-shutdown 410c is performed.

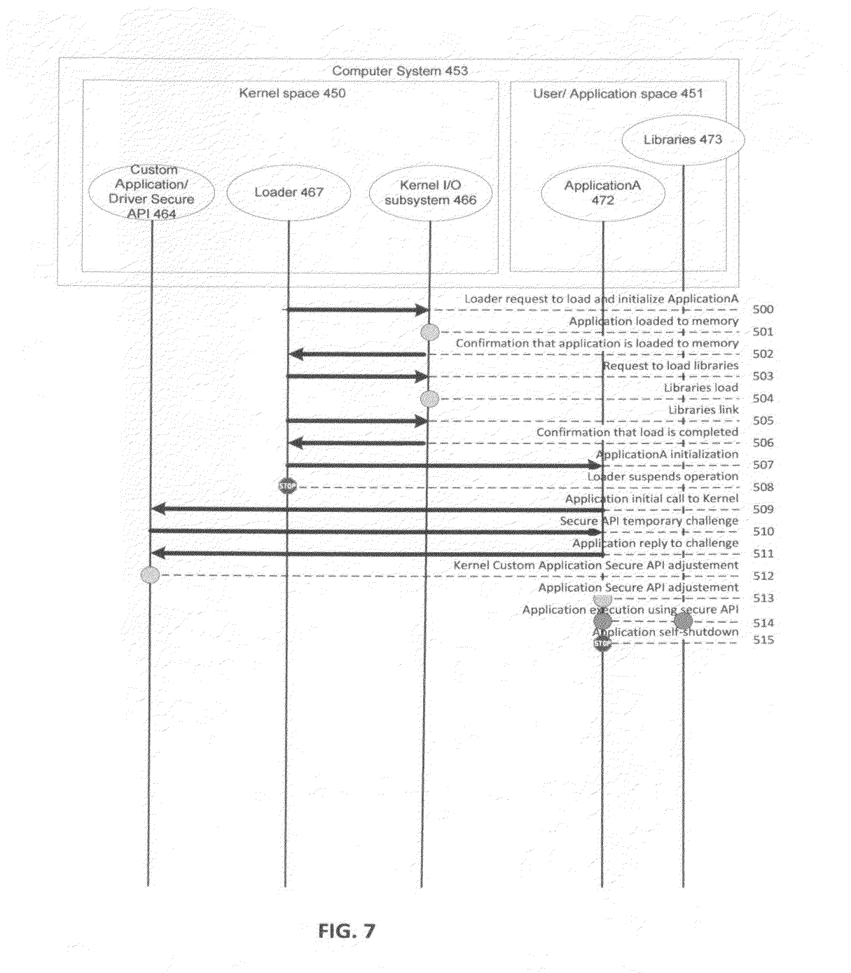

FIG. 7 illustrates the operations during “Application invocation sequence” according to present invention. Application invocation begins from an event triggering Loader request to load and initialize ApplicationA 500. Request is sent by Loader 467 to Kernel I/O subsystem 466 and Application is loaded to memory 501. Loader 467 receives confirmation from Kernel I/O subsystems 466 in step indicating Confirmation that application is loaded to memory 502. In the following, Loader 467 issues Request to load libraries 503 to Kernel I/O subsystem 466. Libraries 473 are required by already loaded ApplicationA 472. After completion of Libraries load 504, Loader performs links Libraries link 505 operation with already loaded ApplicationA 472. When Libraries link 505 operation is completed Confirmation that load is completed 506 is issued to Loader 467. In the following Loader 467 issues Application initialization 507 request and Loader suspends operation 508. During initial stages of its execution ApplicationA 472 performs Application initial call to Kernel 509. Application makes kernel call through its own Custom Application/Driver Secure API 464. Initial call triggers generation of unique Secure API temporary challenge 510 to calling ApplicationA 472. ApplicationA 472 sends Application reply to challenge 511 to Custom Application/Driver Secure API 464. Custom Application Secure API 464 validates correctness of the reply and upon its approval performs Kernel Custom Application Secure API adjustment 512. ApplicationA 472 also performs Application Secure API adjustment 513. ApplicationA 472 continues its execution and interoperates with Computer System 453 through Application execution using secure API 514 up to completion of the execution and its Application self-shutdown 515

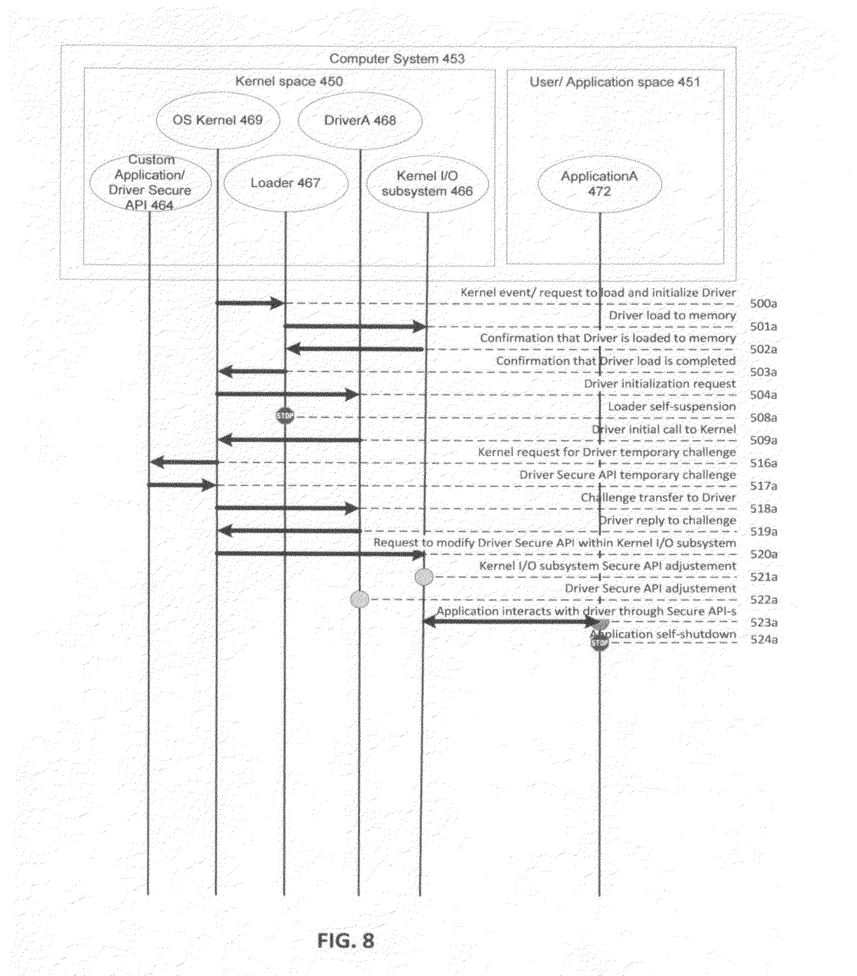

FIG. 8 illustrates the operations during “Driver invocation sequence” according to present invention. Driver invocation begins from kernel event/request to load and initialize Driver 500a. Request is sent from OS Kernel 469 to kernel Loader 467. Loader invokes Kernel I/O subsystem 466 and performs Driver load to memory 501a. I/O kernel subsystem notifies Loader 467 about loading completion by issuing Confirmation that Driver is loaded to memory 502a. In the following Loader 467 notifies OS Kernel 469 by issuing Confirmation that Driver is loaded to memory 503a. OS kernel 469 sends Driver initialization request 504a to DriverA 468. Loader 467 performs Loader self-suspension 508a operation. During driver initialization procedure DriverA 468 performs its Driver initial call to Kernel 509a. In response to DriverA 468 initial call OS Kernel 469 issues Kernel request for Driver temporary challenge 516a request to Custom Application/Driver Secure API 464. Custom Application/Driver Secure API 464 replies with Driver Secure API temporary challenge 517a to OS Kernel 469. OS Kernel 469 performs Challenge transfer to Driver 518a. DriverA in response sends Driver reply to challenge 519a to OS Kernel 469. OS Kernel validates correctness of the reply and upon its approval sends request to modify Driver Secure API within Kernel I/O subsystem 520. Kernel I/O subsystem 466 performs Kernel I/O subsystem Secure API adjustment 521a. Adjustment is based on challenge and reply. Similar operation is performed by DriverA during Driver Secure API adjustment 522a step. In the following ApplicationA 472 continues interacts with DriverA 468 through Kernel I/O subsystem using its own Secure API. DriverA 468 interacts with Kernel I/O subsystem using its own Secure API. Upon ApplicationA 472 completion—it performs its Application self-shutdown 524a

It will also be understood that, in addition to maintaining the security of running applications, installed drivers and integrity of Computer System, the described method can be used as an operational computing platform to monitor, report and log all malicious operations performed by individual applications, drivers and users of Computer System.

It is further intended that any other embodiments of the present invention that result from any changes in application or method of use or operation, method of manufacture, shape, operational environment which are not specified within the detailed written description or illustrations contained herein yet are considered apparent or obvious to one skilled in the art are within the scope of the present invention.

What is claimed is:

1. A secure computing system, comprising:
a. A computer application;
b. A memory, storing said computer application;
c. A processor;
d. A real time clock;
e. A peripheral device;
f. A device driver associated with said peripheral device;
g. An operating system controlling execution of said computer application and said additional peripheral device;
h. A unique system identifier;
i. A application identifier generation model, generating an unique application identifier;
j. A driver identifier generation model, generating an unique driver identifier;
k. A cryptographic expansion module to said operating system, creating an application programming interface for said computer application;
l. A cryptographic expansion module to said operating system, creating an application programming interface for said device driver;

2. The system as claimed in claim 1, further running multiple said computer applications;

3. The system as claimed in claim 1, further running multiple said peripheral drivers;

4. The system as claimed in claim 1, wherein said application programming interface for said computer application is unique per every executed application;

5. The system as claimed in claim 1, wherein said application programming interface for said device driver is unique per every said device driver per every computer application;

6. The system as claimed in claim 1, wherein it communicates with an external authentication server to authenticate a credential of installed computer application;

7. The system as claimed in claim 1, wherein it communicates with authentication server to authenticate a credential of installed device driver;

8. The system as claimed in claim 1, wherein it communicates with authentication server to authenticate a credential of invoked computer application;

9. The system as claimed in claim 1, wherein it communicates with authentication server to authenticate a credential of invoked device driver;

10. The system as claimed in claim 1, wherein the authentication server function is local within the said system;

11. A method of a secure computing environment, comprising the steps of:
a. Creating the unique application identification for every installed computer application;
b. Creating the unique driver identification for every installed driver;
c. Authenticating the credential of the installed computer application with a authentication server;
d. Authenticating the credential of the installed device driver with a authentication server;
e. Creation the unique application programming interface for every installed computer application;
f. Creation the unique application programming interface for every installed device driver per every installed computer application;
g. Separation of an execution environment associated with the installed application from other installed applications by enforcement of unique application programming interface;

12. A method as claimed in claim 11, wherein the application programming interface is derived from the unique system id, the unique application id, and the unique associated device driver id;

13. A method as claimed in claim 11, wherein the application programming interface is derived from the real time clock state;

14. A method as claimed in claim 11, wherein the application programming interface is unique per very invocation of computer application;

15. A method as claimed in claim 11, wherein the application programming interface is unique per very invocation of computer application and real time clock state;
